(19) United States
(12) Patent Application Publication
(10) Pub. No.: US 2022/0148411 A1
(43) Pub. Date: May 12, 2022

(54) COLLECTIVE ANOMALY DETECTION SYSTEMS AND METHODS

(71) Applicant: Ford Global Technologies, LLC, Dearborn, MI (US)

(72) Inventors: Meghna Menon, Rochester Hills, MI (US); Justin Miller, Berkley, MI (US); Mario Anthony Santillo, Canton, MI (US); Raj Sohmshetty, Canton, MI (US); Matthew Cui, Troy, MI (US); Lorne Forsythe, Novi, MI (US)

(73) Assignee: Ford Global Technologies, LLC, Dearborn, MI (US)

(21) Appl. No.: 17/091,794

(22) Filed: Nov. 6, 2020

(51) Int. Cl. G08B 21/18; G01N 29/14; G01N 29/46; G01S 5/26

(52) U.S. Cl. CPC G08B 21/187; G01N 29/14; G05D 1/0094; G01S 5/26; G01N 29/46

(57) ABSTRACT

A method includes obtaining acoustic data from a plurality of acoustic sensors disposed on one or more mobile systems, one or more fixed infrastructure elements, or a combination thereof. The method includes obtaining image data from a plurality of image sensors disposed on the one or more mobile systems, the one or more fixed infrastructure elements, or a combination thereof. The method includes determining whether the anomalous state is present based on the image data and the acoustic data. The method includes, in response to the anomalous state being satisfied, identifying a location associated with the anomalous state based on the acoustic data and the image data and transmitting a notification based on the anomalous state and the location.

### FIELD

The present disclosure relates to a system and/or method for detecting anomalies in a manufacturing environment.

### BACKGROUND

The statements in this section merely provide background information related to the present disclosure and may not constitute prior art.

In a manufacturing environment, it is desirable to monitor various components to identify and diagnose potential issues and anomalies associated therewith. For example, machine failures can lead to downtime and decrease the efficiency in which a part is manufactured. These issues associated with decreased efficiencies resulting from anomalies in the manufacturing environment, among other issues, are addressed by the present disclosure.

### SUMMARY

This section provides a general summary of the disclosure and is not a comprehensive disclosure of its full scope or all of its features.

The present disclosure provides a method for determining an anomalous state associated with a manufacturing environment. The method includes obtaining acoustic data from a plurality of acoustic sensors disposed on one or more mobile systems, one or more fixed infrastructure elements, or a combination thereof. The method includes obtaining image data from a plurality of image sensors disposed on the one or more mobile systems, the one or more fixed infrastructure elements, or a combination thereof. The method includes determining whether the anomalous state is present based on the image data and the acoustic data. The method includes, in response to the anomalous state being satisfied, identifying a location associated with the anomalous state based on the acoustic data and the image data and transmitting a notification based on the anomalous state and the location.

In some forms, the one or more mobile systems include a robot, a drone, an automated guided vehicle, or a combination thereof.

In some forms, determining the anomalous state is present is further based on temperature data obtained from one or more temperature sensors, vibration data obtained from one or more vibration sensors, pressure data obtained from one or more pressure sensors, location data associated with the anomalous state from one or more location sensors, or a combination thereof.

In some forms, the method further includes performing a discrete wavelet transformation on the acoustic data obtained from the plurality of acoustic sensors, where determining whether the anomalous state is present is further based on one or more extracted coefficients of the discrete wavelet transformation.

In some forms, the discrete wavelet transformation is a Daubechies wavelet transformation, the anomalous state is present in response to the one or more extracted coefficients being equal to one or more reference coefficients of a reference sound entry from among a plurality of reference sound entries stored in a database, and the reference sound entry is categorized as an anomalous sound type.

In some forms, the discrete wavelet transformation is a Daubechies wavelet transformation, and the anomalous state is present in response to the one or more extracted coefficients not being equal to one or more reference coefficients of a plurality of reference sound entries stored in a database.

In some forms, the method further includes triangulating the acoustic data obtained from the plurality of acoustic sensors, where the location associated with the anomalous state is further based on the triangulated acoustic data.

In some forms, the acoustic data is time difference of arrival data, and triangulating the acoustic data further includes determining a first time difference of arrival between a first acoustic sensor and a second acoustic sensor from among the plurality of acoustic sensors, determining a second time difference of arrival between the first acoustic sensor and a third acoustic sensor from among the plurality of acoustic sensors, and determining a third time difference of arrival between the first acoustic sensor and a fourth acoustic sensor from among the plurality of acoustic sensors. The location associated with the anomalous state is based on the first time difference of arrival, the second time difference of arrival, and the third time difference of arrival.

In some forms, the location associated with the anomalous state is further based on a location of each of the first acoustic sensor, the second acoustic sensor, the third acoustic sensor, and the fourth acoustic sensor.

In some forms, determining whether the anomalous state is present based on the image data and the acoustic data is further based on a predefined control hierarchy.

In some forms, determining whether the anomalous state is present based on the image data, the acoustic data, and the predefined control hierarchy further includes comparing the acoustic data with reference acoustic data to generate a first determination indicating whether the anomalous state is present, and, in response to the first determination indicating the anomalous state is present, comparing the image data with reference image data to generate a second determination indicating whether the anomalous state is present. In some forms, determining whether the anomalous state is present based on the image data, the acoustic data, and the predefined control hierarchy further includes determining the anomalous state is present in response to the first determination and the second determination indicating the anomalous state is present.

In some forms, in response to the first determination indicating the anomalous state is not present, the anomalous state is determined to be not present.

In some forms, the method further includes broadcasting a command to a robot to perform an inspection operation proximate the location associated with the anomalous state.

In some forms, the notification is a visual alert configured to identify the location associated with the anomalous state.

The present disclosure provides a method of detecting an anomalous state associated with a manufacturing system. The method includes obtaining acoustic data from a plurality of acoustic sensors disposed on one or more mobile systems, one or more fixed infrastructure elements, or a combination thereof. The method includes obtaining image data from a plurality of image sensors disposed on the one or more mobile systems, the one or more fixed infrastructure elements, or a combination thereof. The method includes extracting one or more coefficients from a Daubechies wavelet transformation of the acoustic data and generating a first determination of whether the anomalous state is present based on the one or more coefficients. The method includes, in response to the first determination indicating the anomalous state is present, generating a second determination of whether the anomalous state is present based on the image data. The method includes, in response to the second determination indicating the anomalous state is present: determining a plurality of time differences of arrival based on the acoustic data, triangulating the plurality of time differences of arrival to identify a location associated with the anomalous state, and transmitting a notification based on the anomalous state and the location.

In some forms, determining the anomalous state is present is further based on temperature data obtained from one or more temperature sensors, vibration data obtained from one or more vibration sensors, pressure data obtained from one or more pressure sensors, location data associated with the anomalous state from one or more location sensors, or a combination thereof.

In some forms, the first determination indicates the anomalous state is present in response to the one or more coefficients being equal to one or more reference coefficients of a reference sound entry from among a plurality of reference sound entries stored in a database.

In some forms, the plurality of time differences of arrival based on the acoustic data further includes a first time difference of arrival between a first acoustic sensor and a second acoustic sensor from among the plurality of acoustic sensors, a second time difference of arrival between the first acoustic sensor and a third acoustic sensor from among the plurality of acoustic sensors, and a third time difference of arrival between the first acoustic sensor and a fourth acoustic sensor from among the plurality of acoustic sensors.

In some forms, the location associated with the anomalous state is further based on a location of each of the first acoustic sensor, the second acoustic sensor, the third acoustic sensor, and the fourth acoustic sensor.

The present disclosure provides a system for determining an anomalous state associated with a manufacturing system. The system includes a processor and a nontransitory computer-readable medium including instructions that are executable by the processor. The instructions include obtaining acoustic data from a plurality of acoustic sensors disposed on one or more mobile systems, one or more fixed infrastructure elements, or a combination thereof. The instructions include obtaining image data from a plurality of image sensors disposed on the one or more mobile systems, the one or more fixed infrastructure elements, or a combination thereof. The instructions include extracting one or more coefficients from a Daubechies wavelet transformation of the acoustic data and generating a first determination of whether the anomalous state is present based on the one or more coefficients. The instructions include, in response to the first determination indicating the anomalous state is present, generating a second determination of whether the anomalous state is present based on the image data. The instructions include, in response to the second determination indicating the anomalous state is present: determining a plurality of time differences of arrival based on the acoustic data, triangulating the plurality of time differences of arrival to identify a location associated with the anomalous state, and transmitting a notification based on the anomalous state and the location.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 illustrates a functional block diagram of a manufacturing environment in accordance with the teachings of the present disclosure;

FIG. 2 illustrates a robot performing the anomaly detection and localization routines in accordance with the teachings of the present disclosure;

FIG. 3 illustrates a drone performing the anomaly detection and localization routines in accordance with the teachings of the present disclosure; and

FIG. 4 illustrates an example control routine in accordance with the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The present disclosure provides an anomaly detection system that detects anomalous states (i.e., operation) in a manufacturing environment using at least one of acoustic sensors, image sensors, and environment sensors. In some forms, the anomaly detection system detects, verifies, and localizes the presence of anomalous states by selectively analyzing the data generated by the acoustic sensors, the image sensors, and/or the environment sensors. The anomaly detection system then generates a notification and/or a task corresponding to the anomalous state (e.g., a remedial action). By selectively analyzing the data generated by the acoustic sensors, the image sensors, and/or the environment sensors to detect, verify, and localize the presence of anomalous states, preventative action can be taken to prevent excessive degradation and/or damage to systems/components in the manufacturing environment. It should be readily understood that the anomaly detection system of the present disclosure addresses other issues and should not be limited to the examples provided herein.

As used herein, “anomalous state” refers to any undesirable operational characteristic, physical characteristic, location, and/or degradation of a component and/or system within a manufacturing environment.

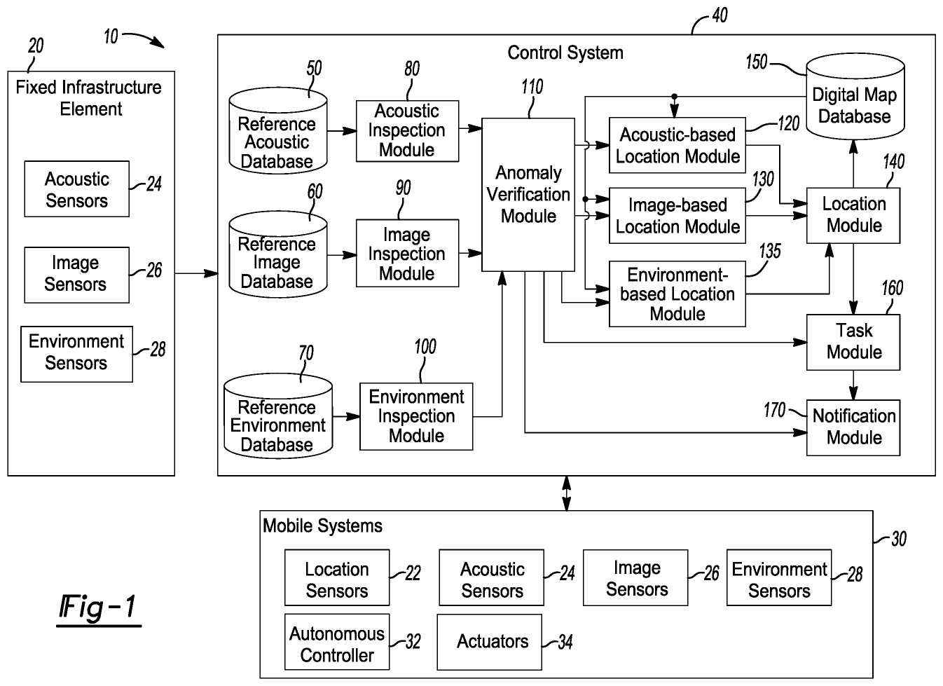

Referring to FIG. 1, a manufacturing environment 10 for manufacturing a component (e.g., a vehicle, engine, climate control system, etc.) is provided. The manufacturing environment 10 generally includes fixed infrastructure elements 20, mobile systems 30, and a control system 40. In one form, location sensors 22, acoustic sensors 24, image sensors 26, and/or environment sensors 28 are disposed on the fixed infrastructure elements 20 and the mobile systems 30. While the control system 40 is illustrated as part of the manufacturing environment 10, it should be understood that the control system 40 may be positioned remotely from the manufacturing environment 10 in other forms. In one form, the location sensors 22, the acoustic sensors 24, the image sensors 26, the environment sensors 28, the mobile systems 30, and the control system 40 are communicably coupled using a wireless communication protocol (e.g., a Bluetooth®-type protocol, a cellular protocol, a wireless fidelity (Wi-Fi)-type protocol, a near-field communication (NFC) protocol, an ultra-wideband (UWB) protocol, among others).

In one form, the fixed infrastructure elements 20 include, but are not limited to: an overhead beam, a tower, a light pole, a building, a sign, a machining device, a stationary storage rack/shelving system, among other fixed elements of the manufacturing environment 10.

In one form, the location sensors 22 provide location data of various objects and systems within the manufacturing environment 10 (e.g., the mobile systems 30, the acoustic sensors 24, among others) to the autonomous controller 32 and/or the control system 40. The location sensors 22 may include, but are not limited to: a global navigation satellite system (GNSS) sensor, a local position sensor (e.g., a UWB sensor), among others.

In one form, the acoustic sensors 24 are sound sensors that provide sound data of the manufacturing environment 10 to an autonomous controller 32 and/or the control system 40. The acoustic sensors 24 may include, but is not limited to, microphones, piezoelectric acoustic sensors, among others. In some forms, the acoustic sensors 24 are disposed throughout the manufacturing environment 10 such that the control system 40 can determine an origin of various sounds in three-dimensional (3D) space, as described below in further detail. As an example, the acoustic sensors 24 are disposed at various fixed infrastructure elements 20 and/or mobile systems 30 (e.g., multiple acoustic sensors 24 are attached to all fixed structures and/or mobile systems 30) such that all sounds generated in the manufacturing environment 10 are detectable by at least set number of acoustic sensors 24 among the plurality of acoustic sensors 24 (e.g., four acoustic sensors 24). In another example, if selected regions of the manufacturing environment 10 are to be monitored, acoustic sensors 24 are positioned at multiple fixed infrastructure elements 20 and/or multiple mobile systems 30 associated with the selected regions such that the sound is detectable by at least set number of acoustic sensors 24. In some forms, the acoustic sensors 24 may include hardware for filtering out undesirable noises of the manufacturing environment 10.

In one form, the image sensors 26 are imaging sensors that provide image data of the manufacturing environment 10 to at least one of the autonomous controller 32 of the mobile systems 30 and the control system 40. The image sensors 26 may include, but are not limited to: a two-dimensional (2D) camera, a 3D camera, an infrared sensor, a radar scanner, a laser scanner, a light detection and ranging (LIDAR) sensor, an ultrasonic sensor, among others.

In one form, the environment sensors 28 are sensors that are configured to provide additional data of the manufacturing environment 10 to at least one of the autonomous controller 32 of the mobile systems 30 and the control system 40. The environment sensors 28 may include, but are not limited to: one or more temperature sensors configured to provide temperature data associated with a component in the manufacturing environment 10, one or more vibration sensors configured to provide vibration data associated with a component in the manufacturing environment 10, and/or one or more pressure sensors configured to provide pressure data associated with a component in the manufacturing environment 10, among others.

In one form, the mobile systems 30 are partially or fully-autonomous and are configured to autonomously move to various locations of the manufacturing environment 10, as instructed by the control system 40. As an example, the mobile systems 30 include, but are not limited to, mobile robots, mobile workstations, drones, and/or automated guided vehicles, among other autonomous devices. To autonomously move itself, the mobile systems 30 include an autonomous controller 32 to control various movement systems of the autonomous device 20 (e.g., propulsion systems, steering systems, and/or brake systems) via actuators 34 and based on the location sensors 22 and/or image data from the image sensors 26. It should be understood that the mobile systems 30 may be fixed within the manufacturing environment 10 in other forms.

In some forms, the control system 40 includes a reference acoustic database 50, a reference image database 60, a reference environment database 70, an acoustic inspection module 80, an image inspection module 90, an environment inspection module 100, and an anomaly verification module 110. The control system 40 may also include an acoustic-based location module 120, an image-based location module 130, an environment-based location module 135, a location module 140, a digital map database 150, a task module 160, and a notification module 170. It should be readily understood that any one of the components of the control system 40 can be provided at the same location or distributed at different locations (e.g., via one or more edge computing devices) and communicably coupled accordingly. While the reference acoustic database 50, the reference image database 60, the reference environment database 70, and the digital map database 150 are illustrated as separate databases, it should be understood that any one of these databases may be selectively combined with another database in other forms.

In one form, the reference acoustic database 50 stores a plurality of reference sound entries, where each reference sound entry identifies a sound category (e.g., an expected sound type for a component in the manufacturing environment 10, an anomalous sound type for a component in the manufacturing environment 10, among others). Furthermore, each reference sound entry may include a wavelet decomposition type (e.g., a Daubechies wavelet transform), detailed coefficients for various decomposition levels, and approximation coefficients for various decomposition levels for performing a discrete wavelet transformation, as described below in further detail.

In one form, the acoustic inspection module 80 obtains the sound data from the plurality of acoustic sensors 24. The acoustic inspection module 80 may perform a signal processing routine (e.g., a discrete wavelet transformation, a Fourier transformation, among others) on the sound data to determine whether an anomalous state exists in the manufacturing environment 10. As an example, the acoustic inspection module 80 performs a Daubechies wavelet transform on the sound data to extract detailed coefficients and approximation coefficients for one or more decomposition levels.

In one form, the acoustic inspection module 80 may search for a reference sound entry from the reference acoustic database 50 with the extracted detailed coefficients and approximation coefficients. As an example, if the acoustic inspection module 80 locates a reference sound entry from the reference acoustic database 50 that is categorized as an expected sound type and includes the extracted detailed coefficients and approximation coefficients, the acoustic inspection module 80 may determine that no anomalous state exists. As another example, if the acoustic inspection module 80 locates a reference sound entry that is categorized as an anomalous sound type and includes the extracted detailed coefficients and approximation coefficients, the acoustic inspection module 80 may determine that an anomalous state exists. As yet another example, if the acoustic inspection module 80 does not locate a reference sound entry that is categorized as an expected sound type and matches the extracted detailed coefficients and approximation coefficients, the acoustic inspection module 80 may determine that an anomalous state exists.

In one form, the reference image database 60 stores a plurality of reference image entries. In one form, each reference image entry may include an image of a given region in the manufacturing environment 10 at a given time for performing a difference-based image processing routine, as described below in further detail. In one form, each reference image entry may include an image of a given region in the manufacturing environment 10, where the image includes semantic markers for performing a semantic-based image processing routine, as described below in further detail.

In one form, the image inspection module 90 obtains the image data from the plurality of image sensors 26. The image inspection module 90 may perform known image processing routines (e.g., a difference-based image processing routine, a semantic-based image processing routine, among others) on the image data to determine whether an anomalous state exists in the manufacturing environment 10. As an example, the image inspection module 90 compares the image data to the reference image entries from the reference image database 60 during a difference-based image processing routine to detect whether an anomalous state exists. As another example, the image inspection module 90 performs a semantic-based image processing routine on the image data and compares the classified objects of the image to the reference image entries to detect whether an anomalous state exists.

In one form, the reference environment database 70 stores a plurality of reference environment entries. In some forms, the reference environment entries include nominal temperature data, nominal vibration data, and/or nominal pressure data associated with a component or location in the manufacturing environment 10. In some forms, the reference environment entries include anomalous temperature data, anomalous vibration data, and/or anomalous pressure data associated with a component or location in the manufacturing environment 10.

In one form, the environment inspection module 100 obtains the environment data from the plurality of environment sensors 28 disposed on the fixed infrastructure elements 20 and the mobile systems 30. In one form, the environment inspection module 100 compares the obtained environment data to the nominal environment data indicated by the reference environment entries from the reference environment database 70 to determine whether an anomalous state exists. As an example, the environment inspection module 100 determines an anomalous state is present if the obtained environment data deviates from the nominal environment data beyond a predefined threshold value.

In one form, the anomaly verification module 110 receives the anomalous state determinations from the acoustic inspection module 80, the image inspection module 90, and the environment inspection module 100 and verifies the presence of the anomalous state based on a predefined control hierarchy being satisfied. In one form, the predefined control hierarchy provides that an anomalous state is present if at least one of the acoustic inspection module 80, the image inspection module 90, or the environment inspection module 100 determine an anomalous state. In another form, the predefined control hierarchy provides that an anomalous state is present if the acoustic inspection module 80 determines the presence of an anomalous state and at least one of the image inspection module 90 or the environment inspection module 100 corroborates the presence of the anomalous state. It should be understood that the predefined control hierarchy can include any combination of the acoustic inspection module 80, the image inspection module 90, and the environment inspection module 100 of determining the presence of the anomalous state and is not limited to the examples provided herein.

In one form, the acoustic-based location module 120 is configured to estimate a location of the anomalous state in response to the acoustic inspection module 80 determining and the anomaly verification module 110 verifying the presence of the anomalous state. In some forms, the acoustic-based location module 120 is configured to estimate an origin of the sound, as the location of the anomalous state, by triangulating the sound data obtained from a plurality of the acoustic sensors 24. As an example, the acoustic-based location module 120 triangulates time difference of arrival data from four or more acoustic sensors 24 to determine the origin of the sound. More particularly, the acoustic-based location module 120 may determine the origin of the sound in 3D space, which is represented as (x, y, z) below, based on the following relations:

$$\begin{matrix}{τ}_{12} = {t}_{2} - {t}_{1} = \frac{1}{c} * \sqrt{{( x - {x}_{2} )}^{2} + {( y - {y}_{2} )}^{2} + {( z - {z}_{2} )}^{2}} - \sqrt{{x}^{2} + {y}^{2} + {z}^{2}} & ( 1 ) \\ {τ}_{13} = {t}_{3} - {t}_{1} = \frac{1}{c} * \sqrt{{( x - {x}_{3} )}^{2} + {( y - {y}_{3} )}^{2} + {( z - {z}_{3} )}^{2}} - \sqrt{{x}^{2} + {y}^{2} + {z}^{2}} & ( 2 ) \\ {τ}_{14} = {t}_{4} - {t}_{1} = \frac{1}{c} * \sqrt{{( x - {x}_{4} )}^{2} + {( y - {y}_{4} )}^{2} + {( z - {z}_{4} )}^{2}} - \sqrt{{x}^{2} + {y}^{2} + {z}^{2}} & ( 3 )\end{matrix}$$

In the above relations, τ₁₂ is the time difference of arrival between a first and second acoustic sensor 24, τ₁₃ is the time difference of arrival between a first and third acoustic sensor 24, τ₁₄ is the time difference of arrival between a first and fourth acoustic sensor 24, and t₁, t₂, t₃, and t₄ are the time values in which the sound data is received by the first through fourth acoustic sensors 24, respectively. In the above relations, x₁, x₂, x₃, and x₄ are the x-coordinates of the first through fourth acoustic sensors 24, respectively, y₁, y₂, y₃, and y₄ are the y-coordinates of the first through fourth acoustic sensors 24, respectively, and z₁, z₂, z₃, and z₄ are the z-coordinates of the first through fourth acoustic sensors 24, respectively. In the above relations, c is the speed of sound. Utilizing the three above relations, the three unknown variables, which are the values of the (x, y, z) coordinate, are determined by the acoustic-based location module 120. In some forms, the speed of sound c may be adjusted to accommodate for thermal gradients caused by varying temperatures and/or pressures of the manufacturing environment 10, as determined by the environment sensors 28 proximate to the first, second, third, and/or fourth acoustic sensors 24. In some forms, the position of the first acoustic sensor 24 may be designated as an origin (i.e., (x₁,y₁,z₁)=(0,0,0)).

In some forms, if one of the acoustic sensors 24 that obtained the sound data is disposed on the mobile system 30 (e.g., a mobile robot), the acoustic-based location module 120 may perform an error correction routine to determine the origin of the sound (e.g., an error estimation routine based on the number of acoustic sensors 24 used and the number of potential sound origins).

In some forms, the acoustic-based location module 120 may corroborate the origin of the sound based on a digital map from the digital map database 150. As an example, the digital map may include digital representations and position coordinates of various objects in the manufacturing environment 10. As such, if the determined origin of sound is proximate (i.e., adjacent and/or near) to position coordinates of one of the objects in the digital map, the acoustic-based location module 120 may corroborate the origin of the sound as determined by the triangulation routine.

In some forms, the acoustic-based location module 120 may corroborate the origin of the sound using location data from the location sensors 22. As an example, if one of the acoustic sensors 24 that obtained the sound data is disposed on the mobile system 30 (e.g., a mobile robot), the acoustic-based location module 120 may corroborate the origin of the sound if the location data from the location sensor 22 of the mobile system 30 is proximate to the determined origin.

In one form, the image-based location module 130 is configured to estimate a location of the anomalous state in response to the image inspection module 90 determining and the anomaly verification module 110 verifying the presence of the anomalous state. As an example, the image-based location module 130 is configured to estimate the location of the anomalous state based on a known position coordinate of the image sensors 26 and known image position to position coordinate conversion relations. In some forms, the image-based location module 130 may corroborate the location of the anomalous state based on the digital map from the digital map database 150 and/or the location data from the location sensors 22 in a similar manner as the acoustic-based location module 120.

In one form, the environment-based location module 135 is configured to estimate a location of the anomalous state in response to the environment inspection module 100 determining and the anomaly verification module 110 verifying the presence of the anomalous state. In some forms, the environment-based location module 135 is configured to estimate an origin of an undesirable vibration or pressure, as the location of the anomalous state, by triangulating the vibration or pressure data obtained from a plurality of the environment sensors 28 (e.g., four or more vibration/pressure sensors) in a similar manner to the sound data described above. In one form, the environment-based location module 135 is configured to estimate an origin of an undesirable temperature, as the location of the anomalous state, based on a temperature value of the environment sensor 28 and a known location of the environment sensor 28. In some forms, the environment-based location module 135 may corroborate the location of the anomalous state based on the digital map from the digital map database 150 and/or the location data from the location sensors 22 in a similar manner as the acoustic-based location module 120.

In one form, the location module 140 receives the estimated locations of the anomalous states from at least one of the acoustic-based location module 120, the image-based location module 130, and the environment-based location module 135 and determines the location of the anomalous state. As an example, the location module 140 determines the location of the anomalous state based on an average of the estimated locations of the anomalous states. It should be understood that any other mathematical representation of the estimated locations of the anomalous states may be utilized and is not limited to the examples provided herein.

In one form, the location module 140 determines the location of the anomalous state based on a predefined location hierarchy. An example predefined control hierarchy includes automatically designating the sound origin as estimated by the acoustic-based location module 120 to be the location. Another example predefined control hierarchy includes disregarding the location estimated by the environment-based location module 135 if the acoustic-based location module 120 and the image-based location module 130 estimate the location of the anomalous state. It should be understood that various predefined control hierarchies can be implemented and are not limited to the examples provided herein.

In one form, the location module 140 updates the digital map of the digital map database 150 based on the determined location of the anomalous state. As an example, the digital map may be tagged with an indicator at the determined location, where the indicator identifies that an anomalous state is occurring/occurred at the determined location.

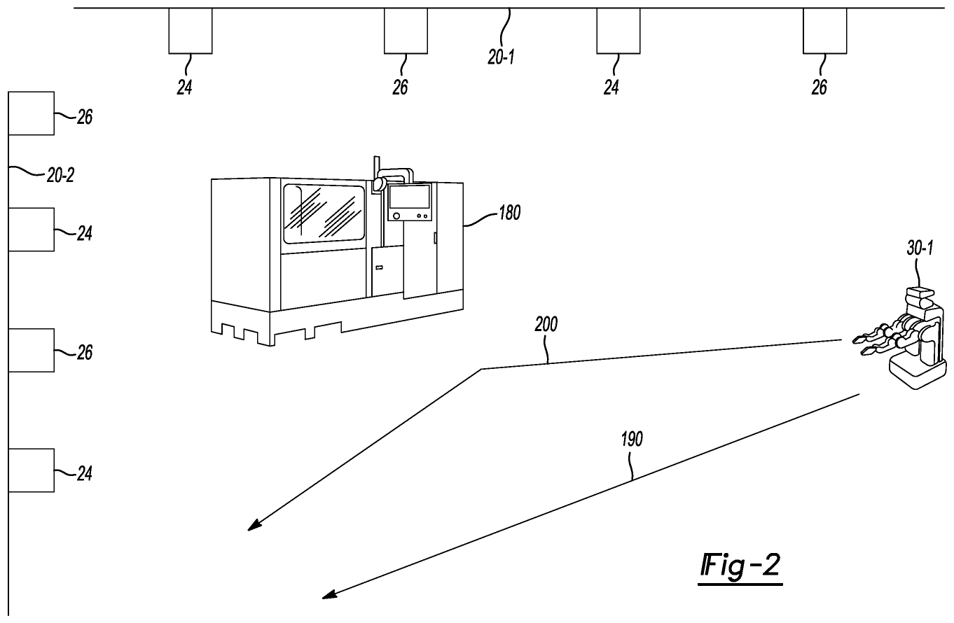

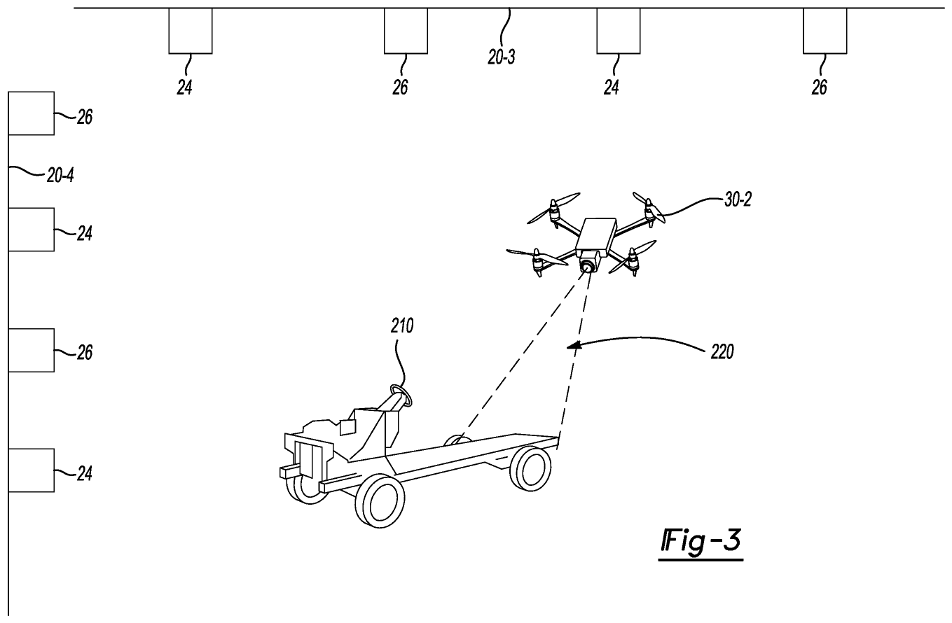

In one form, the task module 160 is configured to define a task (i.e., one or more automated operations to be performed by one of the mobile systems 30) in response to the location module 140 determining the location of the anomalous state. In one form, the task may be defined as an inspection operation (e.g., a visual and/or acoustic inspection) to be performed by a mobile inspection robot, as the mobile system 30, proximate the location of the anomalous state, as described below in further detail with reference to FIG. 2. In one form, the task may be defined as a visual alert operation (e.g., an augmented reality (AR) overlay operation) to be performed by a drone, as the mobile system 30, proximate the location of the anomalous state, as described below in further detail with reference to FIG. 3.

In one form, the notification module 170 is configured to broadcast the defined tasks to the respective mobile systems 30. Furthermore, the notification module 170 may be configured to instruct the mobile systems 30 to autonomously travel to the location of the anomalous state. As an example, the notification module 170 defines paths for the mobile systems 30 to travel along based on the location of the anomalous state. To define the paths, the notification module 170 may perform known path planning routines, maneuver planning routines, and/or a trajectory planning routines.

Referring to FIG. 2, in an example application, acoustic sensors 24 and image sensors 26 are disposed on fixed infrastructure element 20-1 and fixed infrastructure element 20-2, which may be a ceiling beam and pole, respectively. Additionally, location sensors 22, acoustic sensors 24, and image sensors 26 (not shown) are disposed on mobile system 30-1, which may be a mobile robot. The acoustic inspection module 80 obtains sound data from the acoustic sensors 24 and detects an anomalous state, such as an unexpected noise generated by machine 180. The anomaly verification module 110 then verifies that the anomalous state is present in accordance with the predefined control hierarchy providing that only the acoustic inspection module 80 needs to detect an anomalous state for the anomalous state to exist.

The acoustic-based location module 120 then triangulates the sound data to estimate the origin of the sound, which is proximate to the machine 180. The location module 140 then determines the anomalous state to be at the estimated origin of the sound. Subsequently, the task module 160 defines the task as instructing the nearest mobile system 30 (e.g., mobile system 30-1) to perform an inspection operation on the machine 180. Accordingly, the notification module 170 broadcasts a command to the mobile system 30-1 to adjust its original route 190 to route 200 and further inspect the machine 180 to determine whether the machine 180 is damaged. In some forms, the inspection operation performed by mobile system 30-1 includes an iterative closest point (ICP) matching image processing routine, a partial image velocimetry (PIV) image processing routine, among others.

Referring to FIG. 3, in another example application, acoustic sensors 24 and image sensors 26 are disposed on fixed infrastructure element 20-3 and fixed infrastructure element 20-4, which may be a ceiling beam and pole, respectively. Additionally, location sensors 22, acoustic sensors 24, and image sensors 26 (not shown) are disposed on mobile system 30-2, which may be a drone. The acoustic inspection module 80 obtains sound data from the acoustic sensors 24 and detects an anomalous state, such as an unexpected noise resulting from a part of chassis 210 being incorrectly installed. Furthermore, the image inspection module 90 obtains image data from the image sensors 26 disposed on the fixed infrastructure element 20-3 and detects an anomalous state. More particularly, the image inspection module 90 may determine that a part of the chassis 210 is incorrectly installed. The anomaly verification module 110 then verifies that the anomalous state is present in accordance with the predefined control hierarchy, which provides that if the acoustic inspection module 80 detects an anomalous state, the image inspection module 90 must also detect the anomalous state for the anomalous state to exist.

The acoustic-based location module 120 then triangulates the sound data to estimate the origin of the sound, which is estimated to be proximate the rear of the chassis 210. Furthermore, the image-based location module 130 estimates the position of the part defect to be near the rear of the chassis 210 based on the difference-based image processing routine. Based on the estimated locations of the anomalous state, the location module 140 then determines the anomalous state to be at the rear of the chassis 210. Subsequently, the task module 160 defines a task instructing the nearest mobile system 30 (e.g., the mobile system 30-2) to perform a visual alert operation on the chassis 210 (e.g., generate an AR overlay 220 over the rear of the chassis 210). Accordingly, the notification module 170 broadcasts a command to the mobile system 30-2 to travel near the chassis 210 and perform the visual alert operation, thereby notifying nearby operators and/or mobile systems 30 of the incorrect installation.

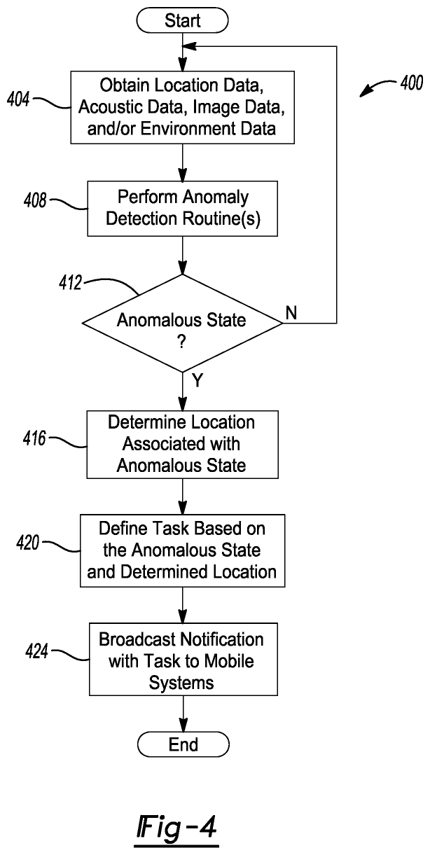

With reference to FIG. 4, a routine 400 for detecting anomalous states and the location of the anomalous state is provided and performed by the control system 40. At 404, the control system 40 obtains location data, acoustic data, image data, and/or environment data from the location sensors 22, the acoustic sensors 24, the image sensors 26, and/or the environment sensors 28, respectively. At 408, the control system 40 performs the anomaly detection routines and determines whether the anomalous state exists at 412. If the anomalous state exists at 412, the routine 400 proceeds to 416. Otherwise, if the anomalous state does not exist at 412, the routine 400 proceeds to 404. At 416, the control system 40 determines the location associated with the anomalous state and defines the task based on the anomalous state and determined location at 420. At 424, the control system 40 broadcasts the notification with the task to one of the mobile systems 30.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice; material, manufacturing, and assembly tolerances; and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

In the figures, the direction of an arrow, as indicated by the arrowhead, generally demonstrates the flow of information (such as data or instructions) that is of interest to the illustration. For example, when element A and element B exchange a variety of information, but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgments of, the information to element A.

In this application, the term controller may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality, such as, but not limited to, movement drivers and systems, transceivers, routers, input/output interface hardware, among others; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

1. A method of detecting an anomalous state associated with a manufacturing system, the method comprising:
obtaining acoustic data from a plurality of acoustic sensors disposed on one or more mobile systems, one or more fixed infrastructure elements, or a combination thereof;
obtaining image data from a plurality of image sensors disposed on the one or more mobile systems, the one or more fixed infrastructure elements, or a combination thereof;
determining whether the anomalous state is present based on the acoustic data; and
in response to the anomalous state being present:
identifying a location associated with the anomalous state based on the acoustic data and the image data; and
transmitting a notification based on the anomalous state and the location.

2. The method of claim 1, wherein the one or more mobile systems include a robot, a drone, an automated guided vehicle, or a combination thereof.

3. The method of claim 1, wherein determining the anomalous state is present is further based on temperature data obtained from one or more temperature sensors, vibration data obtained from one or more vibration sensors, pressure data obtained from one or more pressure sensors, location data associated with the anomalous state from one or more location sensors, or a combination thereof.

4. The method of claim 1 further comprising performing a discrete wavelet transformation on the acoustic data obtained from the plurality of acoustic sensors, wherein determining whether the anomalous state is present is further based on one or more extracted coefficients of the discrete wavelet transformation.

5. The method of claim 4, wherein:
the discrete wavelet transformation is a Daubechies wavelet transformation;
the anomalous state is present in response to the one or more extracted coefficients being equal to one or more reference coefficients of a reference sound entry from among a plurality of reference sound entries stored in a database; and
the reference sound entry is categorized as an anomalous sound type.

6. The method of claim 4, wherein:
the discrete wavelet transformation is a Daubechies wavelet transformation; and
the anomalous state is present in response to the one or more extracted coefficients not being equal to one or more reference coefficients of a plurality of reference sound entries stored in a database.

7. The method of claim 1 further comprising triangulating the acoustic data obtained from the plurality of acoustic sensors, wherein the location associated with the anomalous state is further based on the triangulated acoustic data.

8. The method of claim 7, wherein the acoustic data is time difference of arrival data, and triangulating the acoustic data further comprises:
determining a first time difference of arrival between a first acoustic sensor and a second acoustic sensor from among the plurality of acoustic sensors;
determining a second time difference of arrival between the first acoustic sensor and a third acoustic sensor from among the plurality of acoustic sensors; and
determining a third time difference of arrival between the first acoustic sensor and a fourth acoustic sensor from among the plurality of acoustic sensors, wherein the location associated with the anomalous state is based on the first time difference of arrival, the second time difference of arrival, and the third time difference of arrival.

9. The method of claim 8, wherein the location associated with the anomalous state is further based on a location of each of the first acoustic sensor, the second acoustic sensor, the third acoustic sensor, and the fourth acoustic sensor.

10. The method of claim 1, wherein determining whether the anomalous state is present based on the acoustic data is further based on a predefined control hierarchy.

11. The method of claim 10 further comprising determining whether the anomalous state is present based on the image data, wherein determining whether the anomalous state is present based on the image data, the acoustic data, and the predefined control hierarchy further comprises:
comparing the acoustic data with reference acoustic data to generate a first determination indicating whether the anomalous state is present;
in response to the first determination indicating the anomalous state is present, comparing the image data with reference image data to generate a second determination indicating whether the anomalous state is present; and
determining the anomalous state is present in response to the first determination and the second determination indicating the anomalous state is present.

12. The method of claim 11, wherein in response to the first determination indicating the anomalous state is not present, the anomalous state is determined to be not present.

13. The method of claim 1 further comprising broadcasting a command to a robot to perform an inspection operation proximate the location associated with the anomalous state.

14. The method of claim 1, wherein the notification is a visual alert configured to identify the location associated with the anomalous state.

15. A method of detecting an anomalous state associated with a manufacturing system, the method comprising:
obtaining acoustic data from a plurality of acoustic sensors disposed on one or more mobile systems, one or more fixed infrastructure elements, or a combination thereof;
obtaining image data from a plurality of image sensors disposed on the one or more mobile systems, the one or more fixed infrastructure elements, or a combination thereof;
extracting one or more coefficients from a Daubechies wavelet transformation of the acoustic data;
generating a first determination of whether the anomalous state is present based on the one or more coefficients;
in response to the first determination indicating the anomalous state is present, generating a second determination of whether the anomalous state is present based on the image data; and
in response to the second determination indicating the anomalous state is present:
determining a plurality of time differences of arrival based on the acoustic data;
triangulating the plurality of time differences of arrival to identify a location associated with the anomalous state; and
transmitting a notification based on the anomalous state and the location.

16. The method of claim 15, wherein determining the anomalous state is present is further based on temperature data obtained from one or more temperature sensors, vibration data obtained from one or more vibration sensors, pressure data obtained from one or more pressure sensors, location data associated with the anomalous state from one or more location sensors, or a combination thereof.

17. The method of claim 15, the first determination indicates the anomalous state is present in response to the one or more coefficients being equal to one or more reference coefficients of a reference sound entry from among a plurality of reference sound entries stored in a database.

18. The method of claim 15, wherein the plurality of time differences of arrival based on the acoustic data further comprises:
a first time difference of arrival between a first acoustic sensor and a second acoustic sensor from among the plurality of acoustic sensors,
a second time difference of arrival between the first acoustic sensor and a third acoustic sensor from among the plurality of acoustic sensors, and
a third time difference of arrival between the first acoustic sensor and a fourth acoustic sensor from among the plurality of acoustic sensors.

19. The method of claim 18, wherein the location associated with the anomalous state is further based on a location of each of the first acoustic sensor, the second acoustic sensor, the third acoustic sensor, and the fourth acoustic sensor.

20. A system for determining an anomalous state associated with a manufacturing system, the system comprising:
a processor; and
a nontransitory computer-readable medium including instructions that are executable by the processor, wherein the instructions include:
obtaining acoustic data from a plurality of acoustic sensors disposed on one or more mobile systems, one or more fixed infrastructure elements, or a combination thereof;
obtaining image data from a plurality of image sensors disposed on the one or more mobile systems, the one or more fixed infrastructure elements, or a combination thereof;
extracting one or more coefficients from a Daubechies wavelet transformation of the acoustic data;
generating a first determination of whether the anomalous state is present based on the one or more coefficients;
in response to the first determination indicating the anomalous state is present, generating a second determination of whether the anomalous state is present based on the image data; and
in response to the second determination indicating the anomalous state is present:
determining a plurality of time differences of arrival based on the acoustic data;
triangulating the plurality of time differences of arrival to identify a location associated with the anomalous state; and
transmitting a notification based on the anomalous state and the location.
